(19) United States
(12) Patent Application Publication
(10) Pub. No.: US 2026/0110597 A1
(43) Pub. Date: Apr. 23, 2026

(54) METHODS AND APPARATUSES FOR FLAMMABILITY TESTING

(71) Applicant: Gulfstream Aerospace Corporation, Savannah, GA (US)

(72) Inventors: Mitch Townsend, Savannah, GA (US); Randy Nengel, Savannah, GA (US); Brian Tweet, Savannah, GA (US); JoaoPaulo Silva, Savannah, GA (US)

(73) Assignee: Gulfstream Aerospace Corporation, Savannah, GA (US)

(21) Appl. No.: 18/918,512

(22) Filed: Oct. 17, 2024

(51) Int. Cl. G01M 99/00

(52) U.S. Cl. CPC G01M 99/002

(57) ABSTRACT

Methods and apparatuses for performing flammability testing are provided. A flammability testing apparatus includes a wind tunnel having a testing chamber with first and second walls, wherein the first wall includes a lateral opening, an upstream module, a downstream module, and flexible ducts interconnecting the testing chamber and the modules. The apparatus further includes a coupon configured to seal the lateral opening; a fan configured to pull air out of the downstream module; a flow restrictor configured to restrict a flow of air into the upstream module, wherein the fan and the flow restrictor are configured to maintain a selected flow velocity and a selected pressure in the testing chamber adjacent to a backside of the coupon; a flame thrower configured to apply a flame to a frontside of the coupon; and a shaker platform configured to apply an excitation input to the testing chamber.

### TECHNICAL FIELD

The technical field relates generally to flammability testing, and more particularly relates to an apparatus for performing flammability testing on a testing article and to methods for performing flammability testing.

### BACKGROUND

Various authorities throughout the world have the responsibility for establishing and enforcing regulatory requirements for civil aviation. Such regulatory requirements include safety regulations on transport category airplanes that are quite extensive. Implementation and enforcement processes for civil aviation are considerably more intricate and involved than those imposed by other regulatory agencies on land-based and water-based transport vehicles.

Among the required tests for transport category airplanes are flammability tests. These tests apply to various components regarding their usage and sometimes the materials of which the components are made.

Therefore, certain testing requires establishing flight conditions around a testing article while applying a flame to the testing article. For example, an air flow may be applied to the testing article to establish a pressure and velocities similar to a typical flight, while a flame is applied to the testing article.

Due to the wide variety of articles undergoing testing, testing apparatuses are typically built on an ad hoc basis and are dedicated to the particular testing article, as well as the testing article's size and shape. Such a process is time-consuming, expensive and may not provide adequate testing.

Accordingly, it is desirable to provide flammability testing apparatuses and methods that address one or more of the foregoing issues. Furthermore, other desirable features and characteristics of the various embodiments described herein will become apparent from the subsequent detailed description and the appended claims, taken in conjunction with the accompanying drawings and this background.

### SUMMARY

Various non-limiting embodiments of methods and apparatuses for performing flammability testing are provided herein.

In a first non-limiting embodiment, a flammability testing apparatus includes a wind tunnel having a testing chamber with first and second walls, wherein the first wall includes a lateral opening, an upstream module, a downstream module, and flexible ducts interconnecting the testing chamber and the modules. The apparatus further includes a coupon configured to seal the lateral opening; a fan configured to pull air out of the downstream module; a flow restrictor configured to restrict a flow of air into the upstream module, wherein the fan and the flow restrictor are configured to maintain a selected flow velocity and a selected pressure in the testing chamber adjacent to a backside of the coupon; a flame thrower configured to apply a flame to a frontside of the coupon; and a shaker platform configured to apply an excitation input to the testing chamber.

In certain embodiments of the flammability testing apparatus, the coupon comprises or holds a test article undergoing a flammability test.

In certain embodiments of the flammability testing apparatus, the second wall includes a transparent window for viewing the backside of the coupon.

In certain embodiments of the flammability testing apparatus, the wind tunnel has an upstream internal height within the upstream module; the wind tunnel has a downstream internal height within the downstream module; the wind tunnel has a testing internal height within the testing chamber; and the upstream internal height and the downstream internal height are substantially equal to reduce turbulent air flow through the wind tunnel.

In certain embodiments, the flammability testing apparatus further includes an upstream channel depth adjustment module interconnecting the upstream flexible duct and the testing chamber; and a downstream channel depth adjustment module interconnecting the testing chamber and the downstream flexible duct.

In certain embodiments of the flammability testing apparatus, the upstream module comprises two interconnected upstream chambers; and the downstream module comprises two interconnected downstream chambers.

In certain embodiments, the flammability testing apparatus further includes a bypass valve formed in the downstream module; and a control module configured to adjust a fan speed of the fan, a restriction area of the flow restrictor, and a bypass area of the bypass valve.

In certain embodiments, the flammability testing apparatus further includes sensors located in the testing chamber to monitor temperature and pressure.

In another non-limiting embodiment, a method for performing a flammability test includes preparing a wind tunnel comprising: a testing chamber having a first wall and a second wall opposite the first wall, wherein the first wall includes a lateral opening; an upstream module located upstream from the testing chamber; and a downstream module located downstream from the testing chamber; securing a coupon in the lateral opening, wherein the coupon comprises or holds a testing article upon which the flammability test is performed, and wherein a backside of the coupon is in fluid communication with an interior of the testing chamber; pulling air out of the downstream module with a fan; restricting air flow into the upstream module with a flow restrictor; and applying a flame to a frontside of the coupon.

In certain embodiments of the method for performing a flammability test, preparing the wind tunnel further includes interconnecting an upstream flexible duct between the testing chamber and the upstream module; interconnecting a downstream flexible duct between the testing chamber and the downstream module; and applying an excitation input to the testing chamber, wherein the upstream flexible duct isolates the upstream module from the excitation input, and wherein the downstream flexible duct isolates the downstream module from the excitation input.

In certain embodiments of the method for performing a flammability test, preparing the wind tunnel further includes determining a desired interior width of the testing chamber; assembling the testing chamber with the desired interior width; interconnecting the testing chamber to the upstream flexible duct with an upstream channel depth adjustment module; and interconnecting the testing chamber to the downstream flexible duct with a downstream channel depth adjustment module; wherein the channel depth adjustment modules eliminate/reduce turbulent air flow in the testing chamber.

In certain embodiments of the method for performing a flammability test, the downstream module is formed with a bypass valve, and the method further includes adjusting a fan speed of the fan, a restriction area of the flow restrictor, and a bypass area of the bypass valve.

In certain embodiments, the method for performing a flammability test further includes monitoring temperature and pressure with sensors in the testing chamber.

In certain embodiments, the method for performing a flammability test further includes fabricating the coupon, wherein the lateral opening has a selected shape and size, and wherein the coupon is fabricated with a mating shape and size to seal the lateral opening.

In certain embodiments of the method for performing a flammability test, the testing article is an aircraft component.

In certain embodiments of the method for performing a flammability test, preparing the wind tunnel includes providing the upstream module with an upstream internal height; providing the downstream module with a downstream internal height; and providing the testing chamber with a testing internal height; wherein the upstream internal height and the downstream internal height are substantially equal to reduce turbulent air flow through the wind tunnel.

In another non-limiting embodiment, a method for performing a flammability test includes assembling a testing chamber with a desired interior width, wherein the testing chamber is formed with an opening; locating the testing chamber on a shaker platform; interconnecting the testing chamber to an upstream module with an upstream flexible duct, wherein the upstream module is not located on the shaker platform; interconnecting the testing chamber to a downstream module with a downstream flexible duct, wherein the downstream module is not located on the shaker platform; securing a coupon in the opening, wherein the coupon comprises or holds a testing article upon which the flammability test is performed, and wherein a backside of the coupon is in fluid communication with an interior of the testing chamber; pulling air out of out of the downstream module with a fan; restricting air flow into the upstream module with a flow restrictor; applying a flame to a frontside of the coupon; and applying an excitation input to the testing chamber with the shaker platform.

In certain embodiments, the method for performing a flammability test further includes adjusting a fan speed of the fan and a restriction area of the flow restrictor to adjust a pressure in the testing chamber.

In certain embodiments, the method for performing a flammability test further includes monitoring temperature and pressure with sensors in the testing chamber.

In certain embodiments, the method for performing a flammability test further includes fabricating the coupon, wherein the opening has a selected shape and size, and wherein the coupon is fabricated with a mating shape and size to seal the opening.

### BRIEF DESCRIPTION OF THE DRAWINGS

The various embodiments will hereinafter be described in conjunction with the following drawing figures, wherein like numerals denote like elements, and wherein:

FIG. 1 is a simplified schematic overhead plan illustrating a flammability testing apparatus in accordance with an exemplary embodiment;

FIG. 2 is a schematic cross-sectional view of the flammability testing apparatus of FIG. 1 in accordance with an exemplary embodiment;

FIG. 3 is an exploded view of a testing chamber of the flammability testing apparatus of FIGS. 1 and 2 in accordance with an exemplary embodiment;

FIG. 4 is a perspective view of the bottom half of the assembled testing chamber of the flammability testing apparatus of FIGS. 1 and 2 in accordance with an exemplary embodiment; and

FIG. 5 is a plan view of the assembled testing chamber of the flammability testing apparatus of FIGS. 1 and 2 in accordance with an exemplary embodiment.

### DETAILED DESCRIPTION

The following Detailed Description is merely exemplary in nature and is not intended to limit the various embodiments or the application and uses thereof. Furthermore, there is no intention to be bound by any theory presented in the preceding background or the following detailed description.

The exemplary embodiments taught herein are for use with panels or other components of vehicles, for example, an aircraft or the like.

Exemplary embodiments herein provide an apparatus for performing flammability testing on various testing articles despite structural differences of the testing articles. For example, the testing articles may have different shapes and sizes. Thus, the assembly may include a universal opening for receiving a coupon that is or that holds the testing article. The couple is sized for mating engagement with the universal opening to seal the opening during testing.

Customizability is further enhanced through the use of a reconfigurable testing chamber or section. In addition to changes to the coupon size and shape, the testing chamber is provided with a customizable depth (in the horizontal direction perpendicular to the direction of air flow 101). For example, the testing chamber inlet may be adjustable to provide for appropriate air flow through a desired depth. Also, in certain embodiments, the testing chamber length is adjustable. Further, certain embodiments provide for instrumentation and/or viewing inserts or windows.

Embodiments herein provide increased test accuracy. Embodiments herein decouple testing pressure and testing air flow velocities with closed loop controls. In certain embodiments, the vertical height of the air flow channel is constant through an upstream module, through the testing chamber, and through a downstream module. In certain embodiments, the testing chamber is interconnected to the upstream and downstream modules via a flexible duct or interconnection.

Also, the flammability testing apparatus avoids recirculation of air through the testing chamber. In other words, air passing through the testing chamber is exhausted and is not recycled to pass through the flammability testing apparatus. Thus, the air flow remains clean and false failures may be reduced.

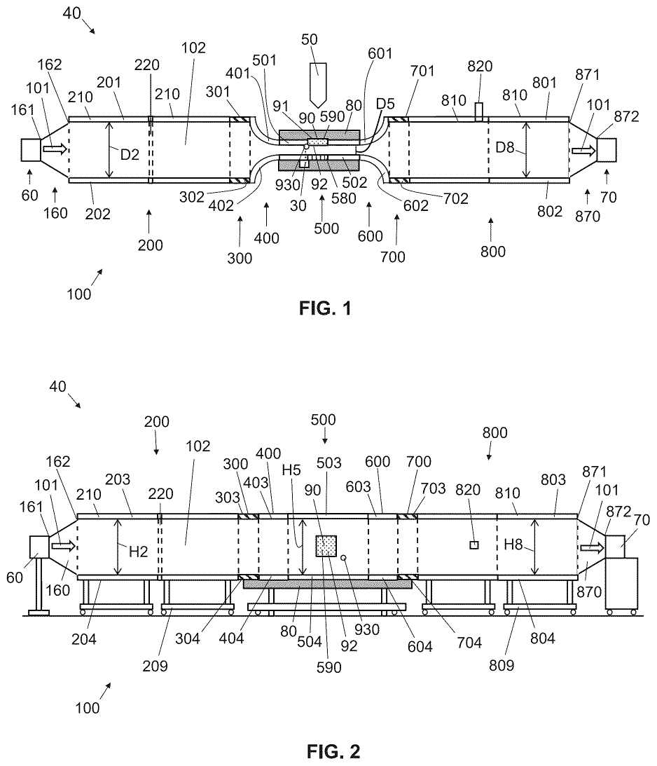

FIG. 1 is a schematic plan view of a flammability testing apparatus 40. FIG. 2 is a schematic cross-sectional view of the flammability testing apparatus 40 of FIG. 1. As shown, the flammability testing apparatus 40 includes a wind tunnel 100 bounding or defining an internal channel 102, a fan 70 configured to pull air out of the wind tunnel 100 as air flow 101, a flow restrictor 60 configured to restrict the air flow 101 into the wind tunnel 100, a flame thrower 50, a shaker platform 80, and a control module or data acquisition system (DAS) 30 configured to adjust a fan speed of the fan 70 and a restriction area of the flow restrictor 60 to control and maintain a selected flow velocity and a selected pressure in the wind tunnel 100. The air flow 101 passes through the internal channel 102 defined by the wind tunnel 100.

The wind tunnel 100 includes a testing chamber or section 500. As shown in FIG. 1, the testing chamber 500 has a first wall 501 and an opposite second wall 502. In exemplary embodiments, the first wall 501 and the second wall 502 are planar, vertical, and parallel. It is contemplated that in certain embodiments it may be desirable to form one or both of the walls 501 and 502 as non-planar and/or as non-parallel. The first wall 501 of the testing chamber 500 is formed with a lateral opening 590, i.e., an opening 590 in a horizontal direction perpendicular to the direction of air flow 101.

The flammability testing apparatus 40 further includes a coupon 90 configured to seal the lateral opening 590 in the first wall 501 of the testing chamber 500. The coupon 90 may be or may form a test article undergoing the flammability test. In other embodiments, the coupon 90 may hold a test article undergoing a flammability test. For example, the test article may be an external panel of an aircraft. In such cases, the panel itself is formed to fit in and seal the opening 590 as the coupon 90. In other cases, it is desirable to perform a flammability test on a smaller feature that is not large enough to cover the opening 590. In such cases, the smaller feature, i.e., the testing article, is supported by the coupon 90. In each case, the coupon 90 and testing article have a backside 92 facing the interior of the testing chamber 500 and have a frontside 91 facing the flame thrower 50.

In certain embodiments, the second wall 502 of the testing chamber 500 includes a transparent window 580 for viewing the interior of the testing chamber 500, and specifically for viewing the backside 92 of the coupon 90.

As further shown in FIG. 1, the testing chamber 500 may include sensors 930 for monitoring conditions within the testing chamber 500. For example, the sensors 930 may include thermocouples, pressure transducers, pitot tubes for measuring statis and dynamic pressures, and other conditions.

The sensors 930 may be connected to the data acquisition system (DAS) 30. Further, the sensors 930 may provide two sets of data, i.e., a control system set used for the control of the testing apparatus and a data system set recorded as testing results.

As shown in FIG. 1, the first wall 501 is distanced from the second wall 502 by a depth D5, in the horizontal direction perpendicular to the direction of air flow 101. As described below, the testing chamber 500 may be configured to provide a desired depth D5 in the testing chamber 500 without reconfiguring the rest of the wind tunnel 100. In certain embodiments, the adjusted depth D5 may be from 0.75 to 4 inches, such as 3 inches.

As shown in FIG. 2, the testing chamber 500 has a third wall or ceiling 503 and an opposite fourth wall or floor 504. In exemplary embodiments, the third wall 503 and the fourth wall 504 are planar, vertical, and parallel. It is contemplated that in certain embodiments it may be desirable to form one or both of the walls 503 and 504 as non-planar and/or as non-parallel.

The third wall 503 is distanced from the fourth wall 504 by a height H5, in the vertical direction perpendicular to the direction of air flow 101. In certain embodiments, the height H5 may be from 12 to 36, such as 24 inches.

In FIGS. 1 and 2, the wind tunnel 100 further includes an upstream module 200 located upstream from the testing chamber 500. As illustrated, the upstream module 200 includes two upstream sections 210; however, the upstream module 200 may be formed from any desired number of sections 210. The sections 210 may be fitted and/or fixed together.

In exemplary embodiments, an airflow straightener 220 may be located between the two sections 210 to remove turbulence downstream from the flow restrictor 60.

In FIG. 1, each section 210 of the upstream module 200 includes a first wall 201 and an opposite second wall 202. In exemplary embodiments, the first wall 201 and the second wall 202 are planar, vertical, and parallel. It is contemplated that in certain embodiments it may be desirable to form one or both of the walls 201 and 202 as non-planar and/or as non-parallel. As shown, the first wall 201 is distanced from the second wall 202 by a depth D2. In certain embodiments, depth D2 may be from 6 to 18 inches.

In FIG. 2, each section 210 of the upstream module 200 includes a third wall or ceiling 203 and an opposite fourth wall or floor 204. In exemplary embodiments, the third wall 203 and the fourth wall 204 are planar, vertical, and parallel. It is contemplated that in certain embodiments it may be desirable to form one or both of the walls 203 and 204 as non-planar and/or as non-parallel. As shown, the third wall 203 is distanced from the fourth wall 204 by a height H2, in the vertical direction perpendicular to the direction of air flow 101. In certain embodiments, height H2 may be from 12 to 36 inches, such as 24 inches.

In FIGS. 1 and 2, the flammability testing apparatus 40 further includes an upstream transitioning section 160. The upstream transitioning section 160 is provided between the flow restrictor 60 and the upstream module 200. Specifically, the transitioning section 160 has an inlet 161 for receiving air flow 101 from the flow restrictor 60 and an outlet 162 connected to the upstream module 200. The inlet 161 may have a vertical height and lateral depth configured to match the diameter of the flow restrictor 60. The transitioning section 160 steadily increases in height and depth to the outlet 162, which has a vertical height and lateral depth matching the height H2 and depth D2 of the upstream module 200.

In FIGS. 1 and 2, the flammability testing apparatus 40 further includes an upstream flexible duct 300 provided to interconnect the testing chamber 500 and the upstream module 200. Also, the flammability testing apparatus 40 further includes an upstream channel depth adjustment module or nozzle 400 provided to interconnect the testing chamber 500 and the upstream module 200. Specifically, in the illustrated embodiment, the upstream module 200 is connected directly to the upstream flexible duct 300, the upstream flexible duct 300 is connected directly to the upstream nozzle 400, and the upstream nozzle 400 is connected directly to the testing chamber 500.

The upstream flexible duct 300 is formed from rubber or another elastomeric material that is not rigid. As a result, vibrations or other mechanical forces are not communicated from the testing chamber 500 to the upstream module 200.

As shown in FIG. 1, the upstream flexible duct 300 includes a first wall 301 and an opposite second wall 302. In exemplary embodiments, the first wall 301 and the second wall 302 are planar, vertical, and parallel. It is contemplated that in certain embodiments it may be desirable to form one or both of the walls 301 and 302 as non-planar and/or as non-parallel. As shown, the first wall 301 is distanced from the second wall 302 by the depth D2.

As shown in FIG. 2, the upstream flexible duct 300 includes a third wall or ceiling 303 and an opposite fourth wall or floor 304. In exemplary embodiments, the third wall 303 and the fourth wall 304 are planar, vertical, and parallel. It is contemplated that in certain embodiments it may be desirable to form one or both of the walls 303 and 304 as non-planar and/or as non-parallel. As shown, the third wall 303 is distanced from the fourth wall 304 by the height H2, in the vertical direction perpendicular to the direction of air flow 101.

As shown in FIG. 1, and as described further below, the upstream nozzle 400 is provided to gradually reduce the depth of the internal channel 102 from depth D2 to depth D5 in the direction of air flow 101 while providing for laminar air flow and/or minimizing turbulent air flow. The upstream nozzle 400 includes a first wall 401 and an opposite second wall 402. In exemplary embodiments, the first wall 401 and the second wall 402 are curved. As shown, the first wall 401 is distanced from the second wall 402 by the depth D2 at the interface with the flexible duct 300. Further, the first wall 401 is distanced from the second wall 402 by the depth D2 at the interface with the testing chamber 500.

As shown in FIG. 2, the upstream nozzle 400 includes a third wall or ceiling 403 and an opposite fourth wall or floor 404. In exemplary embodiments, the third wall 403 and the fourth wall 404 are planar, vertical, and parallel. It is contemplated that in certain embodiments it may be desirable to form one or both of the walls 403 and 404 as non-planar and/or as non-parallel. As shown, the third wall 403 is distanced from the fourth wall 404 by the height H2, in the vertical direction perpendicular to the direction of air flow 101.

In FIGS. 1 and 2, the wind tunnel 100 further includes a downstream module 800 located downstream from the testing chamber 500. As illustrated, the downstream module 800 includes two downstream sections 810; however, the downstream module 800 may be formed from any desired number of sections 810. The sections 810 may be fitted and/or fixed together.

In FIG. 1, each section 810 of the downstream module 800 includes a first wall 801 and an opposite second wall 802. In exemplary embodiments, the first wall 801 and the second wall 802 are planar, vertical, and parallel. It is contemplated that in certain embodiments it may be desirable to form one or both of the walls 801 and 802 as non-planar and/or as non-parallel. As shown, the first wall 801 is distanced from the second wall 802 by a depth D8. In exemplary embodiments depth D8 is equal to depth D2.

In FIG. 2, each section 810 of the downstream module 800 includes a third wall or ceiling 803 and an opposite fourth wall or floor 804. In exemplary embodiments, the third wall 803 and the fourth wall 804 are planar, vertical, and parallel. It is contemplated that in certain embodiments it may be desirable to form one or both of the walls 803 and 804 as non-planar and/or as non-parallel. As shown, the third wall 803 is distanced from the fourth wall 804 by a height H8, in the vertical direction perpendicular to the direction of air flow 101. In exemplary embodiments, height H8 is equal to height H2 and height H5.

In FIGS. 1 and 2, the flammability testing apparatus 40 further includes a downstream transitioning section 870. The downstream transitioning section 870 is provided between the downstream module 800 and the fan 70. Specifically, the downstream transitioning section 870 has an inlet 871 for receiving air flow 101 from the downstream module 800 and an outlet 872 connected to the fan 70. The inlet 871 may have a vertical height and lateral depth configured to match the height H8 and depth D8 of the downstream module 800. The transitioning section 870 steadily decreases in height and depth to the outlet 872, which has a vertical height and lateral depth matching the diameter of the fan 70.

In FIGS. 1 and 2, the flammability testing apparatus 40 further includes a downstream flexible duct 700 provided to interconnect the testing chamber 500 and the downstream module 800. Also, the flammability testing apparatus 40 further includes a downstream channel depth adjustment module 600 provided to interconnect the testing chamber 500 and the downstream module 800. Specifically, in the illustrated embodiment, the downstream module 800 is connected directly to the downstream flexible duct 700, the downstream flexible duct 700 is connected directly to the downstream channel depth adjustment module 600, and the downstream channel depth adjustment module 600 is connected directly to the testing chamber 500.

The downstream flexible duct 700 is formed from rubber or another elastomeric material that is not rigid. As a result, vibrations or other mechanical forces are not communicated from the testing chamber 500 to the downstream module 800.

As shown in FIG. 1, the downstream flexible duct 700 includes a first wall 701 and an opposite second wall 702. In exemplary embodiments, the first wall 701 and the second wall 702 are planar, vertical, and parallel. It is contemplated that in certain embodiments it may be desirable to form one or both of the walls 701 and 202 as non-planar and/or as non-parallel. As shown, the first wall 701 is distanced from the second wall 702 by the depth D8.

As shown in FIG. 2, the downstream flexible duct 700 includes a third wall or ceiling 703 and an opposite fourth wall or floor 704. In exemplary embodiments, the third wall 703 and the fourth wall 704 are planar, vertical, and parallel. It is contemplated that in certain embodiments it may be desirable to form one or both of the walls 703 and 704 as non-planar and/or as non-parallel. As shown, the third wall 703 is distanced from the fourth wall 704 by the height H8, in the vertical direction perpendicular to the direction of air flow 101.

As shown in FIG. 1, and as described further below, the downstream channel depth adjustment module 600 is provided to gradually increase the depth of the internal channel 102 from depth D5 to depth D8 in the direction of air flow 101 while providing for laminar air flow and/or minimizing turbulent air flow. The downstream channel depth adjustment module 600 includes a first wall 601 and an opposite second wall 602. In exemplary embodiments, the first wall 601 and the second wall 602 are curved. As shown, the first wall 601 is distanced from the second wall 602 by the depth D8 at the interface with the testing chamber 500. Further, the first wall 601 is distanced from the second wall 602 by the depth D8 at the interface with the flexible duct 700.

As shown in FIG. 2, the downstream channel depth adjustment module 600 includes a third wall or ceiling 603 and an opposite fourth wall or floor 604. In exemplary embodiments, the third wall 603 and the fourth wall 604 are planar, vertical, and parallel. It is contemplated that in certain embodiments it may be desirable to form one or both of the walls 603 and 604 as non-planar and/or as non-parallel. As shown, the third wall 603 is distanced from the fourth wall 604 by the height H8, in the vertical direction perpendicular to the direction of air flow 101.

FIGS. 1 and 2 illustrate that the flammability testing apparatus 40 may include a bypass valve 820 on the downstream module 800. Bypass valve 820 may be opened or closed. When opened, bypass valve 820 defines a bypass flow area for air to escape the internal channel 102. The bypass flow area may be controlled to further adjust the pressure and velocity in the internal channel 102.

The control module 30 is configured to receive data from the sensors 930. Further, the control module 30 is configured to send directions or otherwise control operation of the fan 70, flow restrictor 60, and bypass valve 820. For example, the control module 30 may control the fan speed of the fan 70, the flow restriction area of the flow restrictor 60, and the bypass flow area of the bypass valve 820. As a result, the control module 30, fan 70, flow restrictor 60, and bypass valve 820 may maintain a selected flow velocity and a selected pressure in the wind tunnel 100 generally, and specifically in the testing chamber 500 adjacent to the backside 92 of the coupon 90.

The flame thrower 50 is positioned and operated to apply a flame to a frontside 91 of the coupon 90.

Further, the shaker platform 80 is configured to apply an excitation input to the testing chamber 500. Specifically, and as shown most clearly in FIG. 2, the testing chamber 500 may rest on and be supported by the shaker platform 80. Thus, the shaker platform 80 may shake and/or vibrate, producing the excitation input that is communicated to the testing chamber 500. The channel depth adjustment modules 400 and 600 may also be supported by, and shaken by, the shaker platform 80. However, the flexible ducts 300 and 700 absorb the excitation input and do not communication the excitation input to the modules 200 and 800. As shown in FIG. 2, the modules 200 and 800 are independently supported by wheeled carriers 209 and 809. As a result, the impact of shaking or vibrations on structures is limited to the testing chamber 500 and the channel depth adjustment modules 400 and 600.

Cross-referencing FIGS. 1 and 2, it is understood that the wind tunnel 100 has an upstream internal height H2 within the upstream module 200, a downstream internal height H8 within the downstream module 800, and a testing internal height H5 within the testing chamber 500. In certain embodiments, the upstream internal height H2, the downstream internal height H8, and the testing internal height H5 are equal to reduce turbulent air flow through the wind tunnel 100. In other embodiments, the upstream internal height H2, the downstream internal height H8, and the testing internal height H5 may vary. More specifically, testing internal height H5 may differ from the upstream internal height H2 and the downstream internal height H8.

Further, the wind tunnel 100 has an upstream internal depth D2 within the upstream module 200, a downstream internal depth D8 within the downstream module 800, and a testing internal depth D5 within the testing chamber 500. Further, the upstream internal depth D2 and the downstream internal depth D8 may be substantially equal to enhance operation. The testing internal depth D5 is selected for the testing article or coupon undergoing the flammability test. In other words, the testing internal depth D5 is adjustable. Further, the channel depth adjustment modules 400 and 600 provide a smooth transition in depth to and from the depth D5 of the testing chamber 500 to reduce turbulent air flow through the testing chamber 500.

In exemplary embodiments, the fan speed of the fan 70 and the restriction area of the flow restrictor 60 are controlled to maintain a speed of air flow 101 through the testing chamber 500 of 0 to 190 feet/second, such as 165 feet/second, and a pressure at a 3″ depth in the testing chamber of from 0 to negative 1.8, such as negative 1.8 pounds per square inch (psi).

In an exemplary embodiment, the apparatus of FIGS. 1 and 2 is used in a method for performing a flammability test. The method includes forming the coupon 90 as the testing article or with the testing article. The coupon 90 may be formed with a universal perimeter for connection to the testing chamber 500. Specifically, the opening 590 in the testing chamber 500 has a selected shape and size, and the coupon 90 is fabricated with a mating shape and size to seal the opening 590.

Based on the testing article, a depth D5 for testing the testing article is determined. In the method, the wind tunnel 100 is prepared by assembling the testing chamber 500 with the desired depth D5 between the first wall 501 and the second wall 502. The testing chamber 500 is located on the shaker platform 80.

Then the testing chamber 500 may be fixed to the channel depth adjustment modules 400 and 600. The channel depth adjustment modules 400 and 600 may be fixed to the flexible ducts 300 and 700 before or after fixing the testing chamber 500 to the channel depth adjustment modules 400 and 600.

The method then includes the upstream module 200 upstream from the testing chamber 500 and locating the downstream module 800 located downstream from the testing chamber 500. The upstream module 200 is secured to the upstream flexible duct 300 and the downstream module 800 is secured to the downstream flexible duct 700.

Further, the flow restrictor 60 is connected to the upstream module 200 and the fan 70 is connected to the downstream module 800.

The method further includes securing the coupon 90 in the lateral opening 590 with the frontside 91 of the coupon 90 forming an exterior surface of the wind tunnel 100 and the backside 92 of the coupon 90 bounds and is in fluid communication with an interior of the testing chamber 500.

Testing is commenced by pulling air out of the downstream module 800 with the fan 70 while restricting air flow into the upstream module 200 with the flow restrictor 60. The fan 70 and flow restrictor 60 may be controlled to provide desired pressures in the testing chamber 500. When the desired conditions are obtained, the method includes applying the excitation input from the shaker support 80 to the testing chamber 500 and applying a flame to the frontside 91 of the coupon 90. Typically, the test is performed for a selected time duration, such as fifteen minutes.

During the test, the sensors 930 record data and the condition of the backside 92 of the coupon 90 may be viewed and/or video recorded through the window 580. Further during the test, the flexible ducts 300 and 700 isolate the module 200 and 800 from the excitation input.

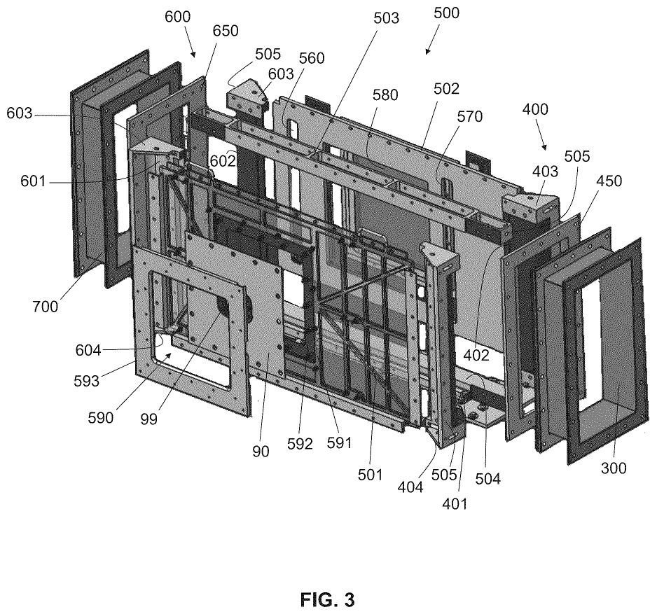

Referring now to FIG. 3, an exploded view of a testing chamber 500 is illustrated. It is noted that the first wall 501 is shown with skin removed to allow for viewing components behind the first wall 501. As shown, a third wall (ceiling) 503 and fourth wall (floor) 504 of a selected depth are provided. The first wall 501 and second wall 502 may be fixed to the third wall 503 and fourth wall 504. Thus, the depth of the testing chamber 500 is determined by the selection of the third wall 503 and fourth wall 504. In certain embodiments, a set of third and fourth walls 503 and 504 having various depths may be stored for selection.

As shown in FIG. 3, the first wall 501 is formed with a lateral opening 590. The lateral opening 590 in the first wall 501 may be formed with a universal size and shape. For example, the opening 590 may be square, rectangular or other suitable shape. Further, the second wall 502 is formed with a transparent window 580 directly opposite the opening 590. Also, the second wall 502 may be formed with openings 560 for receiving inserts 570. The inserts 570 may include sensors, control modules, or other instrumentation. Thus, such components may be formed in inserts 570 for use with a variety of second walls 502, i.e., they are not dedicated or limited for use only with one second wall 502.

In FIG. 3, an adapter plate 591 is received in and fixed to the opening 590. As shown, the adapter plate 591 is annular, effectively reducing the size of the opening 590. The adapter plate 591 may be selected from a set of adapter plate 591 having a universal outer diameter for engagement with the opening 590 and having different annular widths/lengths to provide different inner diameter sizes to allow for testing of coupons having different sizes. In certain embodiments, the adapter plate 591 includes posts or extensions along the periphery of the reduced-size opening 590.

Further, a gasket 592 is received on the posts of the adapter plate 591. For example, the gasket 592 includes openings for receiving the posts. The gasket 592 may be compressible to allow for a tight seal between the coupon 90 and the adapter plate 591. Accordingly, the coupon 90 includes peripheral bores to receive the posts of the adapter plate 591.

Also, an annular cover plate 593 is provided to compress the coupon 90 against the adapter plate 591. In certain embodiments, a fire retardant material such as wool may be located under the cover plate 593.

The coupon 90 of the embodiment of FIG. 3 holds a testing article 99 at a central area of the coupon 90. The testing article 99 extends through the frontside 91 and the backside 92 of the coupon 90 so that the testing article 99 is both contacted by the flame and exposed to the air flow 101 and conditions within the internal channel 102 of the wind tunnel 100 (shown in FIGS. 1 and 2). In other embodiments, the entire coupon 90 is the testing article 99. Further, in certain embodiments, the testing article 99 is large enough for use without the adapter assembly to fit the testing article 99 to the testing chamber 500.

As shown in FIG. 3, the testing chamber 500 is configured to attachment to the adjacent upstream nozzle 400 and the adjacent downstream channel depth adjustment module 600. Specifically, an outer face of first wall 401 of module 400 and an outer face of first wall 601 of module 600 are configured for engagement with an inner face of the first wall 501; and an outer face of second wall 402 of module 400 and an outer face of second wall 602 of module 600 are configured for engagement with an inner face of the second wall 502. Inner faces of the third walls 403 and 603 of modules 400 and 600 are configured for engagement with the third wall 503; and inner faces of the fourth walls 404 and 604 of modules 400 and 600 are configured for engagement with the fourth wall 504.

The channel depth adjustment modules 400 and 600 and the ends 505 of the third and fourth walls 503 and 504 form outer annular edges 550 of the testing chamber 500. As shown, the modules 400 and 600 may include annular frames 450 and 650 for connection to the outer annular edges 550 of the testing chamber 500.

Further, flexible ducts 300 and 700 are configured for engagement to the annular frames 450 and 650.

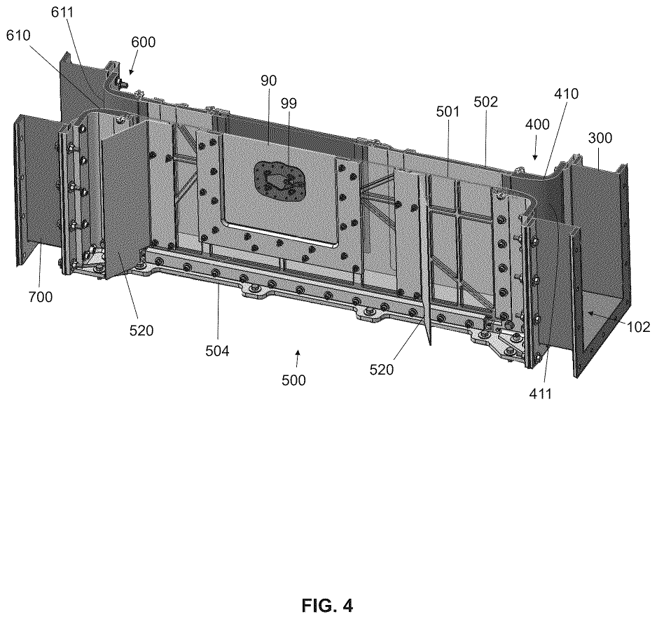

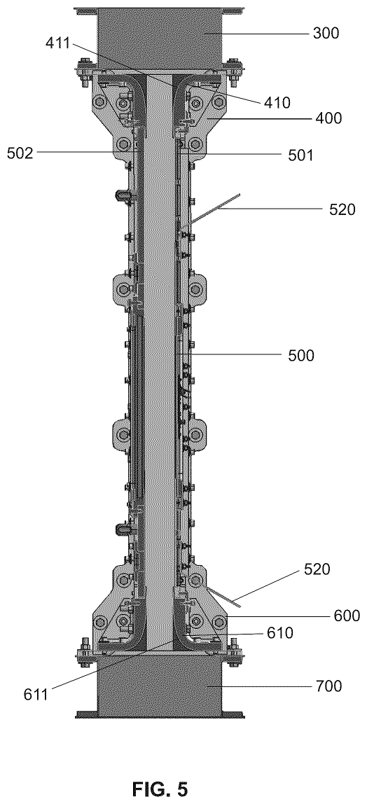

FIGS. 4 and 5 illustrate the components of FIG. 3 after assembly. Further, FIGS. 4 and 5 illustrate that the testing chamber 500 may further include flame shields 520 on the front face of the first wall 501.

Also, FIGS. 4 and 5 illustrates that the channel depth adjustment modules 400 and 600 each include opposite curvilinear walls 410 and 610 that provide a gradual change in depth of the internal channel 102 to inhibit turbulent flow of air through the testing chamber 500. The inner face 411 of each curvilinear wall 410 is aligned with the inner face of each respective wall 501 and 502, such that the transition between the curvilinear wall 410 and the walls 501 and 502 is smooth. Likewise, the inner face 611 of each curvilinear wall 610 is aligned with the inner face of each respective wall 501 and 502, such that the transition between the curvilinear wall 610 and the walls 501 and 502 is smooth.

In certain embodiments, the wind tunnel is designed and configured to allow for load application via an actuator in plane with the testing article 99, such as when the testing article 99 has a latch or other feature that may see loading in flight. The actuator may attach to the table or the third wall 503 spine and would apply load vertically/horizontally (in line with flow) to the exterior (flame side) of the testing article 99.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing an exemplary embodiment of the disclosure. It being understood that various changes may be made in the function and arrangement of elements described in an exemplary embodiment without departing from the scope of the disclosure as set forth in the appended claims.

What is claimed is:

1. A flammability testing apparatus comprising:
a wind tunnel comprising:
a testing chamber having a first wall and a second wall opposite the first wall, wherein the first wall includes a lateral opening;
an upstream module located upstream from the testing chamber;
a downstream module located downstream from the testing chamber;
an upstream flexible duct interconnecting the testing chamber and the upstream module; and
a downstream flexible duct interconnecting the testing chamber and the downstream module;
a coupon configured to seal the lateral opening;
a fan configured to pull air out of the downstream module;
a flow restrictor configured to restrict a flow of air into the upstream module, wherein the fan and the flow restrictor are configured to maintain a selected flow velocity and a selected pressure in the testing chamber adjacent to a backside of the coupon;
a flame thrower configured to apply a flame to a frontside of the coupon; and
a shaker platform configured to apply an excitation input to the testing chamber.

2. The flammability testing apparatus of claim 1, wherein the coupon comprises or holds a test article undergoing a flammability test.

3. The flammability testing apparatus of claim 1, wherein the second wall includes a transparent window for viewing the backside of the coupon.

4. The flammability testing apparatus of claim 1, wherein:
the wind tunnel has an upstream internal height within the upstream module;
the wind tunnel has a downstream internal height within the downstream module;
the wind tunnel has a testing internal height within the testing chamber; and
the upstream internal height and the downstream internal height are substantially equal to reduce turbulent air flow through the wind tunnel.

5. The flammability testing apparatus of claim 1, further comprising:
an upstream channel depth adjustment module interconnecting the upstream flexible duct and the testing chamber; and
a downstream channel depth adjustment module interconnecting the testing chamber and the downstream flexible duct.

6. The flammability testing apparatus of claim 1, wherein:
the upstream module comprises two interconnected upstream chambers; and
the downstream module comprises two interconnected downstream chambers.

7. The flammability testing apparatus of claim 1, further comprising:
a bypass valve formed in the downstream module; and
a control module configured to adjust a fan speed of the fan, a restriction area of the flow restrictor, and a bypass area of the bypass valve.

8. The flammability testing apparatus of claim 1, further comprising:
sensors located in the testing chamber to monitor temperature and pressure.

9. A method for performing a flammability test, the method comprising:
preparing a wind tunnel comprising:
a testing chamber having a first wall and a second wall opposite the first wall, wherein the first wall includes a lateral opening;
an upstream module located upstream from the testing chamber; and
a downstream module located downstream from the testing chamber;
securing a coupon in the lateral opening, wherein the coupon comprises or holds a testing article upon which the flammability test is performed, and wherein a backside of the coupon is in fluid communication with an interior of the testing chamber;
pulling air out of the downstream module with a fan;
restricting air flow into the upstream module with a flow restrictor; and
applying a flame to a frontside of the coupon.

10. The method of claim 9, wherein preparing the wind tunnel further comprises:
interconnecting an upstream flexible duct between the testing chamber and the upstream module;
interconnecting a downstream flexible duct between the testing chamber and the downstream module; and
applying an excitation input to the testing chamber, wherein the upstream flexible duct isolates the upstream module from the excitation input, and wherein the downstream flexible duct isolates the downstream module from the excitation input.

11. The method of claim 10, wherein preparing the wind tunnel further comprises:
determining a desired interior width of the testing chamber;
assembling the testing chamber with the desired interior width;
interconnecting the testing chamber to the upstream flexible duct with an upstream channel depth adjustment module; and
interconnecting the testing chamber to the downstream flexible duct with a downstream channel depth adjustment module;
wherein the channel depth adjustment modules eliminate/reduce turbulent air flow in the testing chamber.

12. The method of claim 9, wherein the downstream module is formed with a bypass valve, and wherein the method further comprises adjusting a fan speed of the fan, a restriction area of the flow restrictor, and a bypass area of the bypass valve.

13. The method of claim 9, further comprising:
monitoring temperature and pressure with sensors in the testing chamber.

14. The method of claim 9, further comprising:
fabricating the coupon, wherein the lateral opening has a selected shape and size, and wherein the coupon is fabricated with a mating shape and size to seal the lateral opening.

15. The method of claim 9, wherein the testing article is an aircraft component.

16. The method of claim 9, wherein preparing the wind tunnel comprises:
providing the upstream module with an upstream internal height;
providing the downstream module with a downstream internal height; and
providing the testing chamber with a testing internal height;
wherein the upstream internal height and the downstream internal height are substantially equal to reduce turbulent air flow through the wind tunnel.

17. A method for performing a flammability test, the method comprising:
assembling a testing chamber with a desired interior width, wherein the testing chamber is formed with an opening;
locating the testing chamber on a shaker platform;
interconnecting the testing chamber to an upstream module with an upstream flexible duct, wherein the upstream module is not located on the shaker platform;
interconnecting the testing chamber to a downstream module with a downstream flexible duct, wherein the downstream module is not located on the shaker platform;
securing a coupon in the opening, wherein the coupon comprises or holds a testing article upon which the flammability test is performed, and wherein a backside of the coupon is in fluid communication with an interior of the testing chamber;
pulling air out of out of the downstream module with a fan;
restricting air flow into the upstream module with a flow restrictor;
applying a flame to a frontside of the coupon; and
applying an excitation input to the testing chamber with the shaker platform.

18. The method of claim 17, further comprising:
adjusting a fan speed of the fan and a restriction area of the flow restrictor to adjust a pressure in the testing chamber.

19. The method of claim 17, further comprising:
monitoring temperature and pressure with sensors in the testing chamber.

20. The method of claim 17, further comprising:
fabricating the coupon, wherein the opening has a selected shape and size, and wherein the coupon is fabricated with a mating shape and size to seal the opening.
